(19) United States
(12) Patent Application Publication
(10) Pub. No.: US 2017/0048585 A1
(43) Pub. Date: Feb. 16, 2017

(54) METHOD AND ELECTRONIC DEVICE FOR FEEDING BACK VOICE INFORMATION, AND TV SET

(71) Applicants: LE HOLDINGS (BEIJING) CO., LTD., Beijing (CN); LE SHI ZHI XIN ELECTRONIC TECHNOLOGY (TIAN JIN) LIMITED, Tianjin (CN)

(72) Inventors: Yanjing DONG, Tianjin (CN); Fei YAO, Tianjin (CN)

(21) Appl. No.: 15/219,735

(22) Filed: Jul. 26, 2016

Related U.S. Application Data
(63) Continuation of application No. PCT/CN2016/084574, filed on Jun. 2, 2016.

(30) Foreign Application Priority Data
Aug. 12, 2015 (CN) 201510497735.4

(51) Int. Cl. H04N 21/482; H04N 21/422; H04N 21/61; H04N 21/442; G06F 3/16; G10L 17/22

(52) U.S. Cl. CPC H04N 21/482; G06F 3/167; G10L 17/22; H04N 21/6125; H04N 21/44204; H04N 21/42203

(57) ABSTRACT

There is a method and electronic device for feeding back voice information, and a TV set so as to enable a user to feed back a failure encountered by the user via voice information while accessing the TV set, so that the TV set can collect and feed back the voice information of the user to a server to thereby enable the user to feed back the failure so as to address the failure rapidly and effectively. A method for feeding back voice information according to the disclosure includes: if an instruction to enable a voice information feedback interface is received, then outputting the voice information feedback interface including a prompt asking a user to record voice information; receiving and recording the voice information of the user; and transmitting the recorded voice information to a server upon reception of an instruction to submit the recorded voice information.

### CROSS REFERENCE TO RELATED APPLICATIONS

This application is a continuation of International Application No. PCT/CN2016/084574, filed on Jun. 2, 2016, which is based upon and claims priority to Chinese Patent Application No. 201510497735.4, filed on Aug. 12, 2015, the entire contents of which are incorporated herein by reference.

### TECHNICAL FIELD

The disclosure relates to the field of electronic information technologies, and particularly to a method and electronic device for feeding back voice information, and a TV set.

### BACKGROUD

Smart TV sets are intelligent multimedia terminals emerging in response to the trend of networked and intelligentized TV sets, and they can operate to obtain programs from the Internet, video devices, and other sources, and present the programs desirable to consumers on large screens clearly. As the functions of the smart TV sets are increasing, the probability of failures occurring is also increasing, and their users become more and more desiring for feeding back the failures; and particularly the users who use the emerging intelligent devices may more desire for feeding back the failures over a convenient channel.

At preset, there are various manufacturers and disclosures enabling their users to feed back failures on the smart TV sets, but typically some preset types of problems, e.g., interrupted playing, opinions and suggestions, etc, are used due to the limited interaction schemes on the TV sets. The users select a module and submit the problems by switching the focuses. Some of these failures are generally well defined while the products are being designed, but will not be updated, so that if there is any change, then the available types of failures will be augmented or modified through upgrading.

In summary, the failure feedback mechanism while a program is being played on the TV set in the prior art is so inflexible that the user has to select from a limited number of types of failures available from the designer of the product to thereby feed back a failure encountered by the user, but these preset types of failures may not be satisfactory to the user because the user may not effectively convey the failure encountered by the user so that the failure of the user may not be addressed.

### SUMMARY

The disclosure provides a method and electronic device for feeding back voice information, and a TV set so as to enable a user to feed back a failure encountered by the user via voice information while accessing the TV set, so that the TV set can collect and feed the voice information of the user back to a server to thereby enable the user to feed back the failure so as to address the failure rapidly and effectively.

An embodiment of the disclosure provides a method for feeding back voice information, the method including:
if an instruction to enable a voice information feedback interface is received, then outputting the voice information feedback interface including a prompt asking a user to record voice information;
receiving and recording the voice information of the user; and
transmitting the recorded voice information to a server upon reception of an instruction to submit the recorded voice information.

An embodiment of the disclosure provides an electronic device, the device including:
at least one processor; and
a memory communicably connected with the at least one processor for storing instructions executable by the at least one processor, wherein execution of the instructions by the at least one processor causes the at least one processor to:
output a voice information feedback interface including a prompt asking a user to record voice information, if an instruction to enable the voice information feedback interface is received;
receive and record the voice information of the user; and
transmit the recorded voice information to a server upon reception of an instruction to submit the recorded voice information.

An embodiment of the disclosure provides a TV set including the electronic device according to the embodiment of the disclosure, wherein,
the electronic device comprises:
at least one processor; and
a memory communicably connected with the at least one processor for storing instructions executable by the at least one processor, wherein execution of the instructions by the at least one processor causes the at least one processor to:
output a voice information feedback interface comprising a prompt asking a user to record voice information, if an instruction to enable the voice information feedback interface is received;
receive and record the voice information of the user; and
transmit the recorded voice information to a server upon reception of an instruction to submit the recorded voice information.

In the embodiments of the disclosure, if the instruction to enable the voice information feedback interface is received, then the voice information feedback interface including the prompt asking the user to record the voice information will be output; the voice information of the user will be recorded; and the recorded voice information will be transmitted to the server upon reception of the instruction to submit the recorded voice information, so that the user can feed back a failure encountered by the user while accessing the TV set, via the voice information, and thus the TV set can collect and feed the voice information of the user back to the server to thereby enable the user to feed back the failure so as to address the failure rapidly and effectively.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic diagram of a voice information feedback interface according to an embodiment of the disclosure;

FIG. 2 is a schematic diagram of recording voice by a user via the voice information feedback interface according to an embodiment of the disclosure;

FIG. 3 is a schematic diagram of recording voice by the user via the voice information feedback interface according to an embodiment of the disclosure;

FIG. 4 is a schematic flow chart of recording voice information according to an embodiment of the disclosure;

FIG. 5 is a schematic flow chart of a method for feeding back voice information according to an embodiment of the disclosure;

FIG. 6 is a schematic structural diagram of an apparatus for feeding back voice information according to an embodiment of the disclosure;

FIG. 7 is a schematic structural diagram of an electronic device according to an embodiment of the disclosure; and

FIG. 8 is a schematic structural diagram of a TV set according to an embodiment of the disclosure.

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

In the technical solutions according to the embodiments of the disclosure, a user can feed back a failure encountered by the user while accessing a TV set, via voice information, so that the TV set can collect and feed the voice information of the user back to a server to thereby enable the user to feed back the failure so as to address the failure rapidly and effectively.

The technical solutions according to the embodiments of the disclosure will be described below with reference to the drawings.

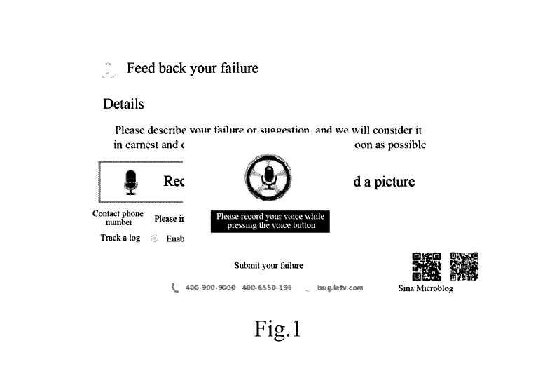

In the technical solutions according to the embodiments of the disclosure, the user can freely feed back a failure encountered while accessing the TV set, without being limited to preset types of failures of the product as in the prior art. In any scenario where the TV set is being accessed, if the user speaks out “I'd like to feed back a failure”, or other keywords to a voice input device on a remote controller, then the TV set will jump directly to a failure feedback disclosure, and present a voice information feedback interface via which the user can feed back the failure by recording the voice, where the voice information feedback interface is as illustrated in FIG. 1, for example.

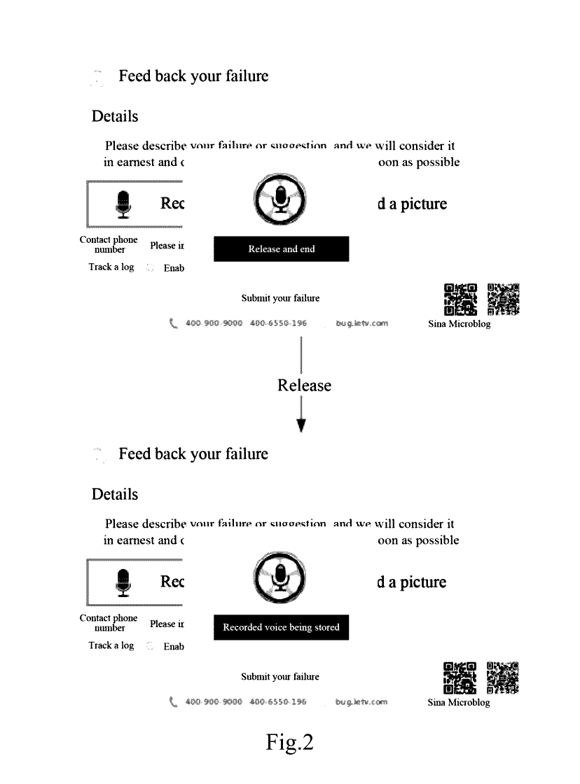

Then in an embodiment of the disclosure, the user records the voice via the voice information feedback interface as illustrated in FIG. 2, where the user can input the voice through a voice input device of the remote controller, and transmit the voice to the TV set, and the TV set can record the voice, so that the user can record a segment of voice describing freely the failure, and particularly the user can record the voice while pressing a voice button on the remote controller in response to a prompt in the voice information feedback interface, and release the voice button on the remote controller after the voice is recorded, so that the recorded voice will be stored automatically into the TV set.

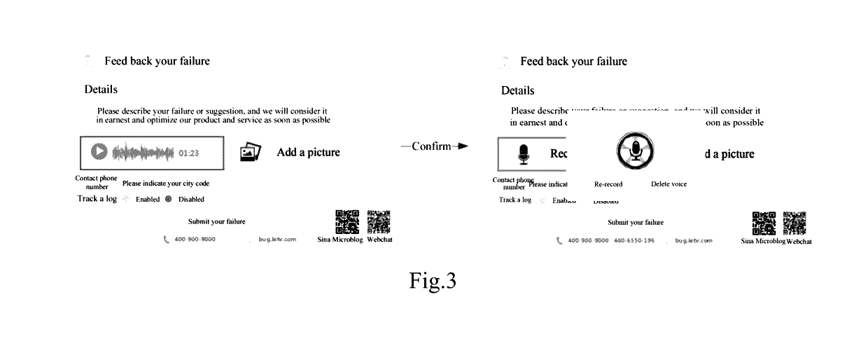

Referring to FIG. 3, a voice file, and the duration, of the segment of recording stored into the TV set will also be displayed on the voice information feedback interface, so that the user can view and play the recorded voice information conveniently. If the viewing user thinks that the voice information is not recorded clearly, or does not express his or her intention explicitly, then the user can choose to record the voice again, and a re-record button will be provided in the voice information feedback interface; and if the user selects this button via the remote controller, then new voice will be recorded again, and the lastly recorded voice file will be deleted after the new voice is recorded. If the user does not want to submit the voice information, then the user can also choose to delete the voice file, through the remote controller.

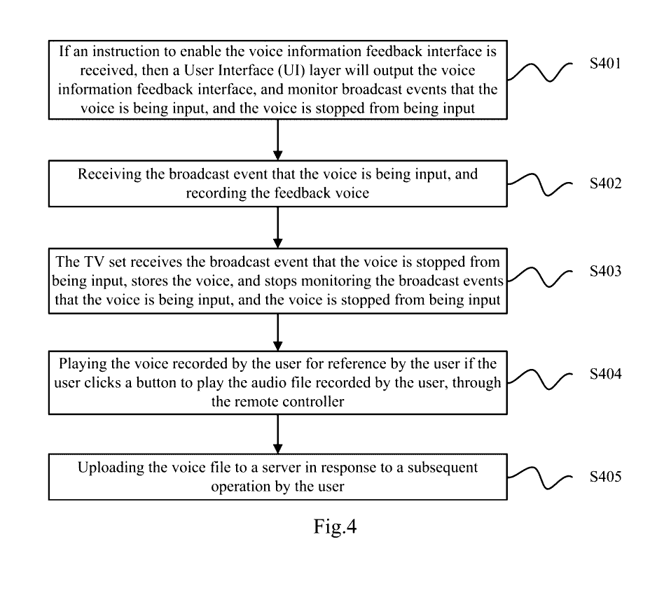

Referring to FIG. 4, the voice information is recorded particularly as follows:

Operation S401: If an instruction to enable the voice information feedback interface is received, then a User Interface (UI) layer will output the voice information feedback interface, and monitor broadcast events that the voice is being input, and the voice is stopped from being input.

Particularly if the instruction to enable the voice information feedback interface is received, then a User Interface (UI) layer will output the voice information feedback interface, for example, if the user inputs a voice instruction of “I'd like to feed back a failure” via voice, or clicks on a “Failure Feedback” icon in a main interface of the TV set, then the voice information feedback interface will be displayed, and if the user clicks on a “Record Voice” button in the voice information feedback interface, then a voice record interface in the form of a dialog will be enabled. At the same time, the UI layer monitors the broadcast events that the voice is being input, and the voice is stopped from being input, and prepares for recoding the voice.

Operation S402: Receiving the broadcast event that the voice is being input, and recording the feedback voice.

If the user manually presses the voice button on the remote controller, then the user will input the voice through the remote controller, and also the TV set will record the voice upon monitoring the broadcast event that the voice is being input, where a voice microphone icon at the UI layer flickers indicating that the voice is being input, and the voice input is recorded.

Operation S403: The TV set receives the broadcast event that the voice is stopped from being input, stores the voice, and stops monitoring the broadcast events that the voice is being input, and the voice is stopped from being input.

if the user manually releases the voice button on the remote controller, then the TV set system will broadcast that the audio of the user is stopped from being input, and the voice microphone icon at the UI layer is set gray to indicate the end of recording the voice of the user. The TV set stores the voice of the user, and stops monitoring the broadcast events that the voice is being input, and the voice is stopped from being input.

Operation S404: Playing the voice recorded by the user for reference by the user if the user clicks a button to play the audio file recorded by the user, through the remote controller.

Subsequent to the operation S403, the audio file of the system is stored into a directory of a memory card of the TV set system, and the UI layer presents the duration of the recorded file to the user. If the user clicks the play button in the interface, then an audio player of the system will be invoked to play the audio recorded by the user.

Operation S405: Uploading the voice file to a server in response to a subsequent operation by the user.

The user operates on the UI layer, where if the user clicks a re-record button, then the lastly recorded voice will be deleted, and the user will be prepared for recording the voice again, and if the user clicks a delete button, then the lastly recorded voice will be deleted, and the process will exit, dependent upon the real recorded voice. If the user clicks a submit button, then a full copy of feedback information will be generated including the voice tile recorded by the user, and submitted to the server.

Here all of the operations of re-recording, deletion, and submission are button options available in the voice information feedback interface, and the user can click the respective buttons through the remote controller.

As can be apparent, with the technical solution according to the embodiment of the disclosure, the failure encountered by the user can be input for a feedback via the voice instead of a text to thereby avoid the shortcoming of the interactive input to the TV set side so as to alleviate the trouble of inputting to the TV set by the user, and the information input by the user can be more detailed so that the failure fed back by the user can be more explicit.

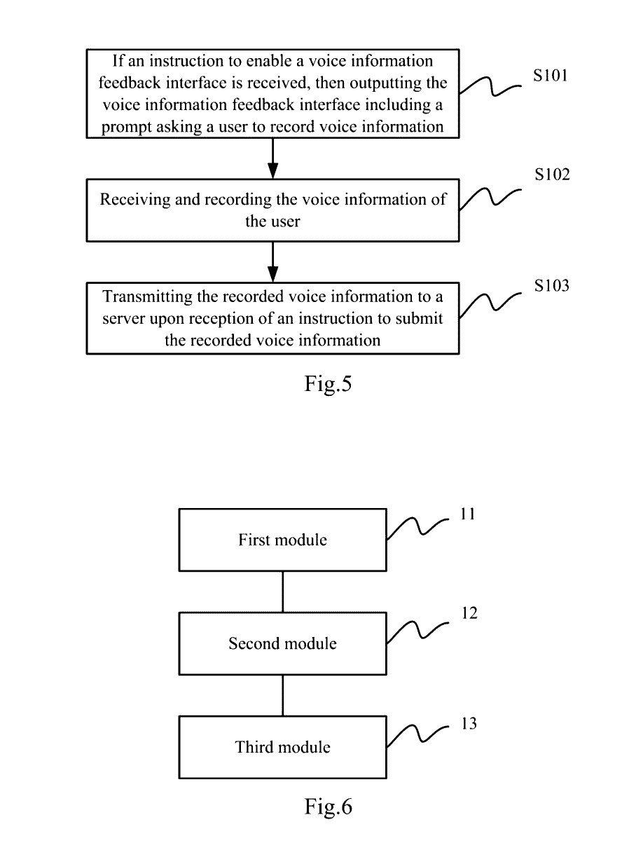

In summary, referring to FIG. 5, a method for feeding back voice at the TV set side according to an embodiment of the disclosure includes the following operations:

S101. If an instruction to enable a voice information feedback interface is received, then outputting the voice information feedback interface including a prompt asking a user to record voice information;

In an embodiment of the disclosure, the instruction to enable the voice information feedback interface can be received by a remote controller, and passed by the remote controller to the TV set; or the instruction to enable a voice information feedback interface can be received directly by the TV set. For example, the instruction to enable a voice information feedback interface is a voice instruction of the user “I'd like to feed back a failure”,

S102: Receiving and recording the voice information of the user;

In an embodiment of the disclosure, the voice information of the user can be received by the remote controller, and transmitted by the remote controller to the TV set; or the voice information of the user can be received directly and recorded by the TV set.

S103: Transmitting the recorded voice information to a server upon reception of an instruction to submit the recorded voice information;

Here, for example, if the instruction to submit the recorded voice information, selected by the user in the voice information feedback interface is received by the remote controller, then the recorded voice information will be transmitted to the server, or if the TV set is a touch-controlled TV set, then if the instruction to submit the recorded voice information, selected through click by the user in the voice information feedback interface is received directly by the TV set, then the recorded voice information will be transmitted to the server.

That is, in an embodiment of the disclosure, the user can operate to feed back the voice information on the TV set cooperating with the remote controller, or if the TV set is a touch-controlled TV set, and provided with the voice input function, then the user can alternatively operate to feed back the voice information directly on the TV set. The TV set can be replaced by a computer, a PAD, a mobile phone, or another terminal device.

Preferably the voice information feedback interface further includes a play button for playing the recorded voice information, and the method further includes:

Playing the recorded voice information upon reception of an instruction of the play button being clicked. For example, if the instruction of the play button being clicked is received by the remote controller, then the recorded voice information will be played.

Preferably if the instruction of the play button being clicked is received, then the method will further include: outputting a prompt interface including a re-record voice information button and/or a delete recorded voice information button.

Preferably the method further includes:

If an instruction of the re-record voice information button being clicked is received, then re-recording the voice information.

Preferably the method further includes:

If an instruction of the delete recorded voice information button being clicked, then deleting the recorded voice information.

Preferably while the voice information feedback interface is being output, the method further includes:

Monitoring broadcast events that the voice is being input, and the voice is stopped from being input.

Preferably the receiving and recording the voice information of the user include:

Receiving the broadcast event that the voice of the user is being output, and recording the voice information of the user; and

Receiving the broadcast event that the voice of the user is stopped from being output, indicating the end of recording the voice of the user in the voice information feedback interface, storing the voice information of the user, and stopping monitoring the broadcast events that the voice is being input, and the voice is stopped from being input.

Corresponding to the method above, referring to FIG. 6, an embodiment of the disclosure provides an apparatus for feeding back voice information, where the apparatus includes:

A first module 11 is configured, if an instruction to enable a voice information feedback interface is received, to output the voice information feedback interface including a prompt asking a user to record voice information;

A second module 12 is configured to receive and record the voice information of the user; and

A third module 13 is configured to transmit the recorded voice information to a server upon reception of an instruction to submit the recorded voice information.

Preferably if the voice information feedback interface further includes a button to play the recorded voice information, then the third module is further configured:

To play the recorded voice information upon reception of an instruction of the play button being clicked.

Preferably upon reception of the instruction of the play button being clicked, the third module is further configured to output a prompt interface including a re-record voice information button and/or a delete recorded voice information button.

Preferably the third module is further configured:

To re-record the voice information upon reception of an instruction of the re-record voice information button being clicked.

Preferably the third module is further configured:

To delete the recorded voice information upon reception of an instruction of the delete recorded voice information button being clicked.

Preferably while the voice information feedback interface is being output, the first module is further configured to monitor broadcast events that the voice is being input, and the voice is stopped from being input.

Preferably the second module is particularly configured:

To receive the broadcast event that the voice is being output, and to record the voice information of the user; and

To receive the broadcast event that the voice is stopped from being output, to indicate the end of recording the voice of the user in the voice information feedback interface, to store the voice information of the user, and to stop monitoring the broadcast events that the voice is being input, and the voice is stopped from being input.

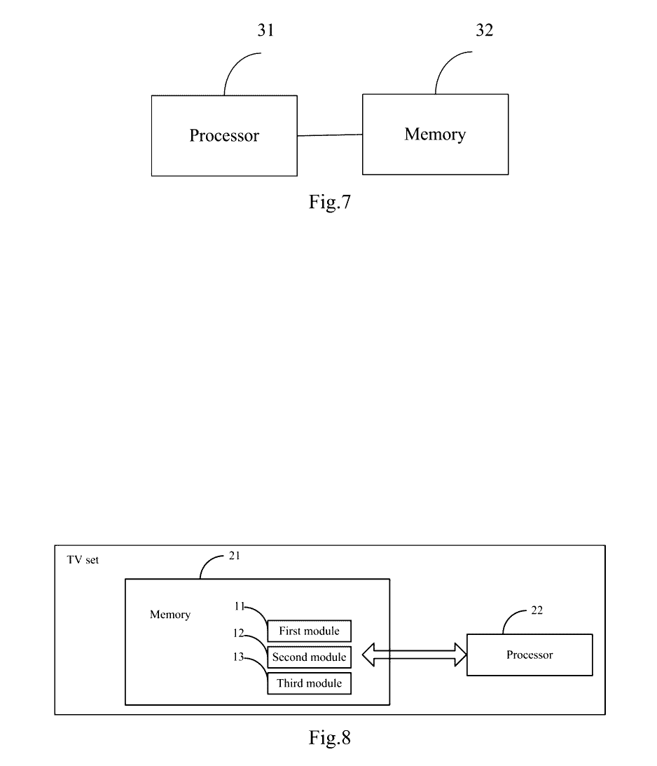

Corresponding to the method above, referring to FIG. 7, an embodiment of the disclosure provides an electronic device, where the device includes:

at least one processor 31 and a memory 32, where there is one processor as an example in FIG. 7.

The memory 32 is communicably connected with the at least one processor for storing instructions executable by the at least one processor, wherein execution of the instructions by the at least one processor causes the at least one processor to:
output a voice information feedback interface comprising a prompt asking a user to record voice information, if an instruction to enable the voice information feedback interface is received;
receive and record the voice information of the user; and
transmit the recorded voice information to a server upon reception of an instruction to submit the recorded voice information.

In one embodiment, if the voice information feedback interface further comprises a button to play the recorded voice information, then the execution of the instructions by the at least one processor further causes the at least one processor to:
play the recorded voice information upon reception of an instruction of the play button being clicked.

In one embodiment, upon reception of the instruction of the play button being clicked, the execution of the instructions by the at least one processor further causes the at least one processor to output a prompt interface comprising a re-record voice information button and/or a delete recorded voice information button.

In one embodiment, while the voice information feedback interface is being output, the execution of the instructions by the at least one processor further causes the at least one processor to monitor broadcast events that the voice is being input, and the voice is stopped from being input.

In one embodiment, the execution of the instructions by the at least one processor further causes the at least one processor to:
receive the broadcast event that the voice of the user is being output, and record the voice information of the user; and
receive the broadcast event that the voice of the user is stopped from being output, indicate the end of recording the voice of the user in the voice information feedback interface, store the voice information of the user, and stop monitoring the broadcast events that the voice is being input, and the voice is stopped from being input.

Referring to FIG. 8, an embodiment of the disclosure includes a TV set including a memory 21, and one or more processors 22, where the TV set further includes a first module 11, a second module 12, and a third module 13, all of which are stored in the memory 21, and configured to be executed by the one or more processor 22;

Where the first module 11 is configured, if an instruction to enable a voice information feedback interface is received, to output the voice information feedback interface including a prompt asking a user to record voice information;

The second module 12 is configured to receive and record the voice information of the user; and

The third module 13 is configured to transmit the recorded voice information to a server upon reception of an instruction to submit the recorded voice information.

An embodiment of the disclosure provides a TV set including the electronic device as illustrated in FIG. 7.

The embodiments of the apparatus described above are merely exemplary, where the units described as separate components may or may not be physically separate, and the components illustrated as elements display may or may not be physical units, that is, they can be collocated or can be distributed onto a number of network elements. A part or all of the modules can be selected as needed in reality for the purpose of the solution according to the embodiments of the disclosure. This can be understood and practiced by those ordinarily skilled in the art without any inventive effort.

Those skilled in the art can appreciate that the respective embodiments described above can be performed by software combined with universal hardware platform, of course they can also be performed by hardware. In this case, the technical solution above in nature or a part of the technical solution that contributed to the existing technology can be embodied in the form of a software product where the software product, including a number of instructions to enable a computor equipment (including a personal computor, a server, or a network equipment, etc.) to perform the methods in the respective embodiments or in a part of the respective embodiments, can be stored in a computer readable storage medium, for example a ROM/RAM, a magnetic disc, an optical disk, etc.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. A method for feeding back voice information, the method comprising:
if an instruction to enable a voice information feedback interface is received, then outputting the voice information feedback interface comprising a prompt asking a user to record voice information;
receiving and recording the voice information of the user; and
transmitting the recorded voice information to a server upon reception of an instruction to submit the recorded voice information.

2. The method according to claim 1, wherein if the voice information feedback interface further comprises a button to play the recorded voice information, then the method further comprises:
playing the recorded voice information upon reception of an instruction of the play button being clicked.

3. The method according to claim 2, wherein upon reception of the instruction of the play button being clicked, the method further comprises outputting a prompt interface comprising a re-record voice information button and/or a delete recorded voice information button.

4. The method according to claim 1, wherein while the voice information feedback interface is being output, the method further comprises:
monitoring broadcast events that the voice is being input, and the voice is stopped from being input.

5. The method according to claim 1, wherein the receiving and recording the voice information of the user comprises:
receiving the broadcast event that the voice of the user is being output, and recording the voice information of the user; and
receiving the broadcast event that the voice of the user is stopped from being output, indicating the end of recording the voice of the user in the voice information feedback interface, storing the voice information of the user, and stopping monitoring the broadcast events that the voice is being input, and the voice is stopped from being input.

6. An electronic device, comprising:
at least one processor; and
a memory communicably connected with the at least one processor for storing instructions executable by the at least one processor, wherein execution of the instructions by the at least one processor causes the at least one processor to:
output a voice information feedback interface comprising a prompt asking a user to record voice information, if an instruction to enable the voice information feedback interface is received;
receive and record the voice information of the user; and
transmit the recorded voice information to a server upon reception of an instruction to submit the recorded voice information.

7. The device according to claim 6, wherein if the voice information feedback interface further comprises a button to play the recorded voice information, then the execution of the instructions by the at least one processor further causes the at least one processor to:
play the recorded voice information upon reception of an instruction of the play button being clicked.

8. The device according to claim 7, wherein upon reception of the instruction of the play button being clicked, the execution of the instructions by the at least one processor further causes the at least one processor to output a prompt interface comprising a re-record voice information button and/or a delete recorded voice information button.

9. The device according to claim 8, wherein while the voice information feedback interface is being output, the execution of the instructions by the at least one processor further causes the at least one processor to monitor broadcast events that the voice is being input, and the voice is stopped from being input.

10. The device according to claim 9, wherein the execution of the instructions by the at least one processor further causes the at least one processor to:
receive the broadcast event that the voice of the user is being output, and record the voice information of the user; and
receive the broadcast event that the voice of the user is stopped from being output, indicate the end of recording the voice of the user in the voice information feedback interface, store the voice information of the user, and stop monitoring the broadcast events that the voice is being input, and the voice is stopped from being input.

11. A TV set, comprising an electronic device, wherein,
the electronic device comprises:
at least one processor; and
a memory communicably connected with the at least one processor for storing instructions executable by the at least one processor, wherein execution of the instructions by the at least one processor causes the at least one processor to:
output a voice information feedback interface comprising a prompt asking a user to record voice information, if an instruction to enable the voice information feedback interface is received;
receive and record the voice information of the user; and
transmit the recorded voice information to a server upon reception of an instruction to submit the recorded voice information.

12. The TV set according to claim 11, wherein if the voice information feedback interface further comprises a button to play the recorded voice information, then the execution of the instructions by the at least one processor further causes the at least one processor to:
play the recorded voice information upon reception of an instruction of the play button being clicked.

13. The TV set according to claim 12, wherein upon reception of the instruction of the play button being clicked, the execution of the instructions by the at least one processor further causes the at least one processor to output a prompt interface comprising a re-record voice information button and/or a delete recorded voice information button.

14. The TV set according to claim 13, wherein while the voice information feedback interface is being output, the execution of the instructions by the at least one processor further causes the at least one processor to monitor broadcast events that the voice is being input, and the voice is stopped from being input.

15. The TV set according to claim 14, wherein the execution of the instructions by the at least one processor further causes the at least one processor to:
receive the broadcast event that the voice of the user is being output, and record the voice information of the user; and
receive the broadcast event that the voice of the user is stopped from being output, indicate the end of recording the voice of the user in the voice information feedback interface, store the voice information of the user, and stop monitoring the broadcast events that the voice is being input, and the voice is stopped from being input.
